(19) United States
(12) Patent Application Publication
(10) Pub. No.: US 2026/0307958 A1
(43) Pub. Date: Oct. 8, 2026

(54) Extension Devices

(71) Applicants: Carnegie Mellon University, Pittsburgh, PA (US); University of Washington, Seattle, WA (US)

(72) Inventors: Jeffrey Lipton, Sharon, MA (US); Sawyer Thomas, North Bend, WA (US); Zachary Manchester, Pittsburgh, PA (US); Mitchell Fogelson, Pittsburgh, PA (US)

(21) Appl. No.: 19/572,195

(22) Filed: Mar. 19, 2026

Related U.S. Application Data
(63) Continuation of application No. PCT/US24/47458, filed on Sep. 19, 2024.
(60) Provisional application No. 63/539,100, filed on Sep. 19, 2023.

(51) Int. Cl. B66F 3/22; B64G 1/22

(52) U.S. Cl. CPC B66F 3/22; B64G 1/2223

(57) ABSTRACT

Provided are extension devices and systems, including an extending truss including a plurality of cells, each cell including a first scissor extender including a first member and a second member rotationally connected to the first member at an off-center point along a longitudinal axis of the first member, a second scissor extender connected to the first scissor extender, the second scissor extender including a first member and a second member rotationally connected to the first member, and a third scissor extender connected to the first scissor extender, the third scissor extender including a first member and a second member rotationally connected to the first member.

### CROSS REFERENCE TO RELATED APPLICATIONS

This application is a United States bypass continuation of International Application No. PCT/US24/47458, filed on Sep. 19, 2024, and claims the benefit of U.S. Provisional Patent Application No. 63/539,100, filed on Sep. 19, 2023, the disclosures of which are hereby incorporated by reference in their entireties.

### GOVERNMENT RIGHTS NOTICE

This invention was made with government support under 80NSSC22K0767 awarded by the National Aeronautics and Space Administration (NASA). The government has certain rights in the invention.

### BACKGROUND OF THE INVENTION

### 1. Field

This disclosure relates generally to extension devices and, in non-limiting embodiments, to extending trusses, hierarchical extension devices, and methods for designing and constructing the same.

### 2. Technical Considerations

Long-duration spaceflight poses serious challenges for the human body, including muscle atrophy, bone loss, eyesight degradation, and immunosuppression. Many of these effects are linked to a lack of gravity, and the ability to generate artificial gravity with a rotating space structure could eliminate their root cause. Such a structure must be able to rotate at rates around 1-2 RPM as humans experience discomfort from exposure to rotation rates as low as 3 RPM. To achieve a centripetal acceleration equivalent to Earth's gravity at 1 RPM, a 1.7-kilometer-long structure is used. A half-kilometer-long structure is used for a spinning rate of 2 RPM, which is generally considered an upper bound for human comfort. A kilometer-scale space structure using current technologies would require dozens of rocket launches. In addition, significant on-orbit assembly and fabrication would drastically increase risk and cost. In principle, a long tether can be used to deploy a rotating space habitat from a single launch. However, tethers have limited ability to transmit mechanical loads, making maneuvering and station-keeping control difficult.

Booms are a critical part of space infrastructure. Numerous boom technologies exist but are still limited by their unpredictable deployability. Their reliance on tensioning cables or buckling elements to deploy and maintain shape is also a limitation of these technologies. Tensegrity designs pack well and are conceptually simple. However, they have two major flaws: first, they rely on cables that only become taut when fully deployed, making tangling during deployment possible. Second, they lack redundancy, and the failure of a single cable can significantly weaken the structure. Tethers are perhaps one of the most straightforward space structures and have been tested in orbit numerous times. The Gemini 11 mission deployed a 100-foot (30-meter) tether between the crewed Gemini capsule and the Agena upper-stage booster. This then spun the combined system up to a rotation rate of 55 degrees per minute to produce an artificial gravity of approximately 0.00015 g. Other notable on-orbit tether deployments include the two Space Shuttle TSS missions flown in 1992 and 1996. All three of these experiments encountered difficulties dealing with the tethers' flexible nature and inability to transmit mechanical loads.

### SUMMARY

According to non-limiting embodiments or aspects, provided is an extending truss comprising a plurality of cells, each cell comprising: a first scissor extender comprising a first member and a second member rotationally connected to the first member at an off-center point along a longitudinal axis of the first member; a second scissor extender connected to the first scissor extender, the second scissor extender comprising a first member and a second member rotationally connected to the first member; and a third scissor extender connected to the first scissor extender, the third scissor extender comprising a first member and a second member rotationally connected to the first member.

In non-limiting embodiments or aspects, the first member and the second member of the first scissor extender each comprise a first end and a second end, the first member and the second member of the second scissor extender each comprise a first end and a second end, the first member and the second member of the third scissor extender each comprise a first end and a second end, and wherein each cell further comprises a plurality of joints including: a first joint connecting the first end of the first member of the second scissor extender with the second end of the second member of the first scissor extender; a second joint connecting the first end of the second member of the second scissor extender with the second end of the first member of the first scissor extender; a third joint connecting the second end of the second member of the third scissor extender with the first end of the first member of the first scissor extender; and a fourth joint connecting the second end of the first member of the third scissor extender with the first end of the second member of the first scissor extender. In non-limiting embodiments or aspects, each joint of the plurality of joints comprises a compliant flexure.

In non-limiting embodiments or aspects, each cell further comprises at least one additional scissor extender comprising a first member and a second member rotationally connected to the first member, the at least one additional scissor extender connected to the first scissor extender, the second scissor extender, and/or the third scissor extender. In non-limiting embodiments or aspects, the plurality of cells are arranged as support members of a Kresling structure. In non-limiting embodiments or aspects, the device includes a locking mechanism configured to lock the first scissor extender, the second scissor extender, and/or the third scissor extender in an at least partially extended state. In non-limiting embodiments or aspects, wherein a length of the first member and the second member of the third scissor extender and/or second scissor extender is shorter than a length of the first member and the second member of the first scissor extender. In non-limiting embodiments or aspects, the first scissor extender further comprises a revolute joint rotationally connecting the first member and the second member of the first scissor extender.

According to non-limiting embodiments or aspects, provided is an extension device comprising: a plurality of first scissor extenders serially connected, at least one first scissor extender of the plurality of first scissor extenders comprising a first member and a second member rotationally connected to the first member at an off-center point along a longitudinal axis of the first member; a plurality of second scissor extenders serially connected, each second scissor extender of the plurality of second scissor extenders comprising a first member and a second member rotationally connected to the first member, the plurality of second scissor extenders connected to the plurality of first scissor extenders; and a plurality of third scissor extenders serially connected, each second scissor extender of the plurality of second scissor extenders comprising a first member and a second member rotationally connected to the first member, the plurality of third scissor extenders connected to the plurality of first scissor extenders.

In non-limiting embodiments or aspects, the device includes: a plurality of joints connecting the plurality of first scissor extenders to the plurality of third scissor extenders and the plurality of second scissor extenders. In non-limiting embodiments or aspects, the plurality of joints comprises compliant flexures. In non-limiting embodiments or aspects, the device includes: a plurality of fourth scissor extenders serially connected, each fourth scissor extender of the plurality of fourth scissor extenders comprising a first member and a second member rotationally connected to the first member, the plurality of fourth scissor extenders connected to the plurality of second scissor extenders and the plurality of three scissor extenders. In non-limiting embodiments or aspects, the plurality of first scissor extenders forms a first elongated member, the plurality of second scissor extenders forms a second elongated member, and the plurality of third scissor extenders forms a third elongated member, and the device includes: a first end connector at a first end of each of the first elongated member, the second elongated member, and the third elongated member; and a second end connector at a second end of each of the first elongated member, the second elongated member, and the third elongated member, the first elongated member, the second elongated member, and the third elongated member are arranged as members of a Kresling structure comprising a top portion connected to at least one first end connector and a bottom portion connected to at least one second end connector.

In non-limiting embodiments or aspects, the device includes a locking mechanism configured to lock a pop-up extender in an at least partially extended position. In non-limiting embodiments or aspects, wherein a length of the first member and the second member of each second scissor extender is shorter than a length of the first member and the second member of each first scissor extender. In non-limiting embodiments or aspects, the extension device is configured to be substantially flat in a configuration where each first scissor extender, each second scissor extender, and each third scissor extender are substantially compressed, and the pop-up extender is configured to form a structure with a three-dimensional cross section in a configuration where each first scissor extender, each second scissor extender, and each third scissor extender are at least partially extended.

According to non-limiting embodiments or aspects, provided is a cell of a pop-up extending truss comprising: a first scissor extender comprising a first member and a second member rotationally connected to the first member at an off-center point along a longitudinal axis of the first member; a second scissor extender connected to the first scissor extender, the second scissor extender comprising a first member and a second member rotationally connected to the first member; and a third scissor extender connected to the first scissor extender, the third scissor extender comprising a first member and a second member rotationally connected to the first member. In non-limiting embodiments or aspects, the first member and the second member of the first scissor extender each comprise a first end and a second end, the first member and the second member of second scissor extender each comprise a first end and a second end, and the first member and the second member of the third scissor extender each comprise a first end and a second end, further comprising: a first joint connecting the first end of the first member of the second scissor extender with the second end of the second member of the first scissor extender; and a second joint connecting the second end of the second member of the third scissor extender with the first end of the first member of the first scissor extender.

In non-limiting embodiments or aspects, the first joint and the second joint each comprise a compliant flexure. In non-limiting embodiments or aspects, a length of the first member and the second member of the second scissor extender is shorter than a length of the first member and the second member of the first scissor extender. In non-limiting embodiments or aspects, the device includes at least one additional scissor extender comprising a first member and a second member rotationally connected to the first member, the first member and the second member of second first scissor extender each having a first end and a second end, the at least one additional scissor extender connected to the first scissor extender, the second scissor extender, and/or the third scissor extender. In non-limiting embodiments or aspects the device includes a locking mechanism configured to lock the first scissor extender, the second scissor extender, and/or the third scissor extender in an at least partially extended state. In non-limiting embodiments or aspects, a length of the first member and the second member of the second scissor extender is shorter than the length of the first member and the second member of the first scissor extender, and wherein a length of the first member and the second member of the third scissor extender is shorter than the length of the first member and the second member of the first scissor extender.

According to non-limiting embodiments or aspects, provided is a hierarchical extension device comprising: a plurality of first extension mechanisms, each first extension mechanism configured to be compressed into a compressed state having a compressed length and extended into an extended state having an extended length; and a second extension mechanism comprising a plurality of members configured to be compressed into a compressed state and extended into an extended state without altering a length of the plurality of members, each member of the plurality of members comprising a first extension mechanism of the plurality of first extension mechanisms.

In non-limiting embodiments or aspects, wherein each first extension mechanism of the plurality of first extension mechanisms comprises at least one scissor extender. In non-limiting embodiments or aspects, wherein each first extension mechanism of the plurality of first extension mechanisms comprises a pop-up extending truss. In non-limiting embodiments or aspects, the second extension mechanism comprises a Kresling structure, and the plurality of members comprises elongated supports for the Kresling structure.

According to non-limiting embodiments or aspects, provided is an extension device, comprising: a first extension assembly comprised of two or more members mechanically fastened such that a first member of the two or more members is pivotable with respect to a second member of the two or more members, wherein pivoting of the first member with respect to the second member compresses and extends the first extension assembly; and a second extension assembly comprised of one or more first extension assemblies, a first end, and a second end.

In non-limiting embodiments or aspects, the first extension assembly maintains a state of compression or a state of extension during rotation of the first end with respect to the second end. In non-limiting embodiments or aspects, wherein rotation of the first end with respect to the second end compresses and extends the second extension assembly. In non-limiting embodiments or aspects, wherein pivoting the first member with respect to the second member compresses and extends the first extension assembly when the second extension assembly is in an extended state. In non-limiting embodiments or aspects, the first extension assembly comprises a plurality of scissor extenders. In non-limiting embodiments or aspects, the second extension assembly comprises a Kresling structure.

Other non-limiting embodiments or aspects will be set forth in the following numbered clauses:

Clause 1: An extending truss comprising a plurality of cells, each cell comprising: a first scissor extender comprising a first member and a second member rotationally connected to the first member at an off-center point along a longitudinal axis of the first member; a second scissor extender connected to the first scissor extender, the second scissor extender comprising a first member and a second member rotationally connected to the first member; and a third scissor extender connected to the first scissor extender, the third scissor extender comprising a first member and a second member rotationally connected to the first member.

Clause 2: The extending truss of clause 1, wherein the first member and the second member of the first scissor extender each comprise a first end and a second end, wherein the first member and the second member of the second scissor extender each comprise a first end and a second end, wherein the first member and the second member of the third scissor extender each comprise a first end and a second end, and wherein each cell further comprises a plurality of joints including: a first joint connecting the first end of the first member of the second scissor extender with the second end of the second member of the first scissor extender; a second joint connecting the first end of the second member of the second scissor extender with the second end of the first member of the first scissor extender; a third joint connecting the second end of the second member of the third scissor extender with the first end of the first member of the first scissor extender; and a fourth joint connecting the second end of the first member of the third scissor extender with the first end of the second member of the first scissor extender.

Clause 3: The extending truss of clause 1 or 2, wherein each joint of the plurality of joints comprises a compliant flexure.

Clause 4: The extending truss of any of claims 1-3, wherein each cell further comprises at least one additional scissor extender comprising a first member and a second member rotationally connected to the first member, the at least one additional scissor extender connected to the first scissor extender, the second scissor extender, and/or the third scissor extender.

Clause 5. The extending truss of any of claims 1-4, wherein the plurality of cells are arranged as support members of a Kresling structure.

Clause 6. The extending truss of any of claims 1-5, further comprising a locking mechanism configured to lock the first scissor extender, the second scissor extender, and/or the third scissor extender in an at least partially extended state.

Clause 7. The extending truss of any of claims 1-6, wherein a length of the first member and the second member of the third scissor extender and/or second scissor extender is shorter than a length of the first member and the second member of the first scissor extender.

Clause 8. The extending truss of any of claims 1-7, wherein the first scissor extender further comprises a revolute joint rotationally connecting the first member and the second member of the first scissor extender.

Clause 9: An extension device comprising: a plurality of first scissor extenders serially connected, at least one first scissor extender of the plurality of first scissor extenders comprising a first member and a second member rotationally connected to the first member at an off-center point along a longitudinal axis of the first member; a plurality of second scissor extenders serially connected, each second scissor extender of the plurality of second scissor extenders comprising a first member and a second member rotationally connected to the first member, the plurality of second scissor extenders connected to the plurality of first scissor extenders; and a plurality of third scissor extenders serially connected, each second scissor extender of the plurality of second scissor extenders comprising a first member and a second member rotationally connected to the first member, the plurality of third scissor extenders connected to the plurality of first scissor extenders.

Clause 10. The extension device of clause 9, further comprising: a plurality of joints connecting the plurality of first scissor extenders to the plurality of third scissor extenders and the plurality of second scissor extenders.

Clause 11: The extension device of clause 9 or 10, wherein the plurality of joints comprises compliant flexures.

Clause 12: The extension device of any of clauses 9-11, comprising: a plurality of fourth scissor extenders serially connected, each fourth scissor extender of the plurality of fourth scissor extenders comprising a first member and a second member rotationally connected to the first member, the plurality of fourth scissor extenders connected to the plurality of second scissor extenders and the plurality of three scissor extenders.

Clause 13. The extension device of any of clauses 9-12, wherein the plurality of first scissor extenders forms a first elongated member, wherein the plurality of second scissor extenders forms a second elongated member, and wherein the plurality of third scissor extenders forms a third elongated member, further comprising: a first end connector at a first end of each of the first elongated member, the second elongated member, and the third elongated member; and a second end connector at a second end of each of the first elongated member, the second elongated member, and the third elongated member, wherein the first elongated member, the second elongated member, and the third elongated member are arranged as members of a Kresling structure comprising a top portion connected to at least one first end connector and a bottom portion connected to at least one second end connector.

Clause 14. The extension device of any of clauses 9-13, further comprising a locking mechanism configured to lock a pop-up extender in an at least partially extended position.

Clause 15. The extension device of any of clauses 9-14, wherein the locking mechanism comprises a member configured to rigidly connect two members of at least one scissor extender.

Clause 16. The extension device of any of clauses 9-15, wherein a length of the first member and the second member of each second scissor extender is shorter than a length of the first member and the second member of each first scissor extender.

Clause 17. The extension device of any of clauses 9-16, wherein the extension device is configured to be substantially flat in a configuration where each first scissor extender, each second scissor extender, and each third scissor extender are substantially compressed, and wherein the pop-up extender is configured to form a structure with a three-dimensional cross section in a configuration where each first scissor extender, each second scissor extender, and each third scissor extender are at least partially extended.

Clause 18: A cell of a pop-up extending truss comprising: a first scissor extender comprising a first member and a second member rotationally connected to the first member at an off-center point along a longitudinal axis of the first member; a second scissor extender connected to the first scissor extender, the second scissor extender comprising a first member and a second member rotationally connected to the first member; and a third scissor extender connected to the first scissor extender, the third scissor extender comprising a first member and a second member rotationally connected to the first member.

Clause 19: The cell of clause 18, wherein the first member and the second member of the first scissor extender each comprise a first end and a second end, wherein the first member and the second member of second scissor extender each comprise a first end and a second end, and wherein the first member and the second member of the third scissor extender each comprise a first end and a second end, further comprising: a first joint connecting the first end of the first member of the second scissor extender with the second end of the second member of the first scissor extender; and a second joint connecting the second end of the second member of the third scissor extender with the first end of the first member of the first scissor extender.

Clause 20: The cell of clause 18 or 19, wherein the first joint and the second joint each comprise a compliant flexure.

Clause 21: The cell of any of clauses 18-20, wherein a length of the first member and the second member of the second scissor extender is shorter than a length of the first member and the second member of the first scissor extender.

Clause 22: The cell of any of clauses 18-21, comprising at least one additional scissor extender comprising a first member and a second member rotationally connected to the first member, the first member and the second member of second first scissor extender each having a first end and a second end, and the at least one additional scissor extender connected to the first scissor extender, the second scissor extender, and/or the third scissor extender.

Clause 23: The cell of any of clauses 18-22, further comprising a locking mechanism configured to lock the first scissor extender, the second scissor extender, and/or the third scissor extender in an at least partially extended state.

Clause 24: The cell of any of clauses 18-23, wherein a length of the first member and the second member of the second scissor extender is shorter than the length of the first member and the second member of the first scissor extender, and wherein a length of the first member and the second member of the third scissor extender is shorter than the length of the first member and the second member of the first scissor extender.

Clause 25: A hierarchical extension device comprising: a plurality of first extension mechanisms, each first extension mechanism configured to be compressed into a compressed state having a compressed length and extended into an extended state having an extended length; and a second extension mechanism comprising a plurality of members configured to be compressed into a compressed state and extended into an extended state without altering a length of the plurality of members, each member of the plurality of members comprising a first extension mechanism of the plurality of first extension mechanisms.

Clause 26: The hierarchical extension device of clause 25, wherein each first extension mechanism of the plurality of first extension mechanisms comprises at least one scissor extender.

Clause 27: The hierarchical extension device of clause 25 or 26, wherein each first extension mechanism of the plurality of first extension mechanisms comprises a pop-up extending truss.

Clause 28: The hierarchical extension device of any of clauses 25-27, wherein the second extension mechanism comprises a Kresling structure, and wherein the plurality of members comprises elongated supports for the Kresling structure.

Clause 29: The hierarchical extension device of any of clauses 25-28, further comprising a locking mechanism configured to lock the hierarchical extension device in an at least partially extended state.

Clause 30: The hierarchical extension device of any of clauses 25-29, further comprising pivotable joints connecting each end of each member of the plurality of members to at least one object.

Clause 31: An extension device, comprising: a first extension assembly comprised of two or more members mechanically fastened such that a first member of the two or more members is pivotable with respect to a second member of the two or more members, wherein pivoting of the first member with respect to the second member compresses and extends the first extension assembly; and a second extension assembly comprised of one or more first extension assemblies, a first end, and a second end.

Clause 32: The extension device of clause 31, wherein the first extension assembly maintains a state of compression or a state of extension during rotation of the first end with respect to the second end.

Clause 33: The extension device of clause 31 or 32, wherein rotation of the first end with respect to the second end compresses and extends the second extension assembly.

Clause 34: The extension device of any of clauses 31-33, wherein pivoting the first member with respect to the second member compresses and extends the first extension assembly when the second extension assembly is in an extended state.

Clause 35: The extension device of any of clauses 31-34, wherein the first extension assembly comprises a plurality of scissor extenders.

Clause 36: The extension device of any of clauses 31-35, wherein the second extension assembly comprises a Kresling structure.

### BRIEF DESCRIPTION OF THE DRAWINGS

Additional advantages and details are explained in greater detail below with reference to the exemplary embodiments that are illustrated in the accompanying schematic figures, in which:

FIGS. 1A and 1B show scissor extenders according to non-limiting embodiments;

FIGS. 2A-2C show an extending truss according to non-limiting embodiments;

FIG. 3 shows an extending truss according to non-limiting embodiments;

FIGS. 4A-4C show views of an extending truss according to non-limiting embodiments;

FIGS. 5A-5D show views of an extending truss in a compressed state according to non-limiting embodiments;

FIGS. 6A-6J show views of an extending truss in an extended state according to non-limiting embodiments;

FIG. 7 shows a hierarchical extension device according to non-limiting embodiments;

FIGS. 8A and 8B show a connection mechanism for use in a hierarchical extension device according to non-limiting embodiments;

FIG. 9A shows a hierarchical extension device in a compressed state according to non-limiting embodiments;

FIG. 9B shows a hierarchical extension device in an extended state according to non-limiting embodiments; and

FIGS. 10A and 10B show a Kresling structure for use in a hierarchical extension device according to non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

In non-limiting embodiments, provided is an extension device that compresses and extends. An extension device may include an extending truss in non-limiting embodiments, which provides structural support in an extended position. The extending truss may “pop-up” in non-limiting embodiments by expanding into a three-dimensional (3D) shape (e.g., having a shaped cross section) from a substantially flat starting position (e.g., compressed). An extending truss may be formed from one or more stacked cells that are connected serially (e.g., as a longitudinal member of multiple cells). Each cell may include at least three extension mechanisms laterally connected together, although it will be appreciated that various numbers of extension mechanisms may be used to create a cell for an extending truss.

The term “extension mechanism” as used herein may refer to any mechanical device that is configured to expand into an extended (e.g., expanded) state and contract into a compressed state. The expansion and contraction may be in one or more directional axes. An extension mechanism may include, for example, a scissor extender. The terms “scissor extender” and “scissor mechanism” as used herein may refer to a device having at least two members rotationally connected such that the two members can rotate into an expanded position and rotate into a compressed position by changing the relative angles between the members. The members of a scissor extender may rotate on the same plane. A scissor extender may include a joint, such as a revolute joint, rotationally connecting the two members on a same plane. The joint may be arranged at the center of a longitudinal axis of each member or may be arranged off-center the longitudinal axis of one or more of the members. For example, an asymmetric scissor mechanism may include a revolute joint connecting two members at a location off-center the longitudinal axis for one or more of the members. A symmetric scissor mechanism may include a revolute joint connecting two members at a center point of the longitudinal axis of each member.

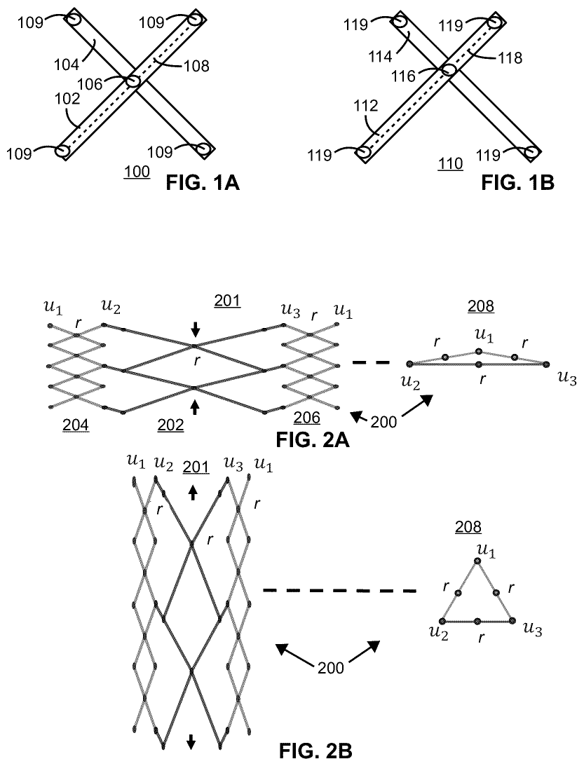

Referring to FIGS. 1A and 1B, shown are scissor extenders 100, 110 usable with non-limiting embodiments of an extending truss discussed herein. The scissor extender 100 shown in FIG. 1A includes a first member 102 and a second member 104, each having a longitudinal axis 108. The first member 102 is rotationally connected to the second member 104 with a revolute joint 106 at a center (e.g., midpoint) of the longitudinal axis 108. The scissor extender 100 shown in FIG. 1A is substantially symmetrical, although symmetry is not necessary in non-limiting embodiments.

The scissor extender 110 shown in FIG. 1B includes a first member 112 and a second member 114, each having a longitudinal axis 118. The first member 112 is rotationally connected to the second member 114 with a revolute joint 116 at a point off-center the longitudinal axis 118 (e.g., located between a midpoint and an end point along the length of the member 112 or 114). The members 112, 114 may be connected at the same off-center point along the longitudinal axis of each member, as shown in FIG. 1B, or may be connected at an off-center point along the longitudinal axis of one member (e.g., 112) and at a central point or different off-center point along the longitudinal axis of the other member (e.g., 114). The scissor extender 110 shown in FIG. 1B is asymmetrical due to the off-center connection point. In non-limiting embodiments, the length of members 112, 114 shown in FIG. 1B may be longer than the length of members 102, 104 shown in FIG. 1A.

With continued reference to FIGS. 1A and 1B, a joint 109, 119 on an end portion of the first member 102, 112 and/or second member 104, 114 may be used to serially connect another scissor extender to form an elongated length of scissor extenders. The joint 109, 119 and/or a co-located joint (e.g., such as a universal joint, flexure, and/or the like) may be used to laterally connect another scissor extender to form a cell of at least three scissor extenders connected laterally. It will be appreciated that different arrangements of members and joints may be used in non-limiting embodiments.

The members 102, 112, 104, 114 may be made from any suitable material such as, but not limited to, aluminum, steel, plastic, and/or the like. The components may be molded, formed, and/or 3D printed, as examples. It will be appreciated that various different materials and manufacturing methods may be used in non-limiting embodiments.

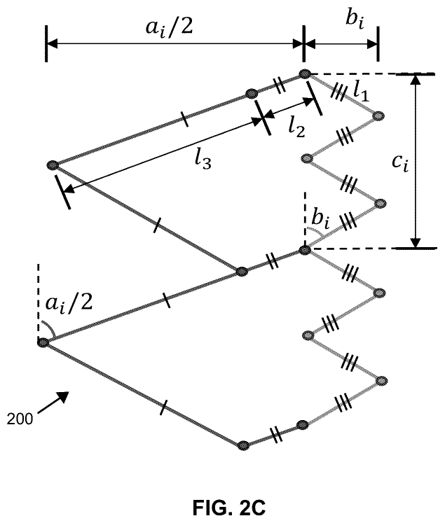

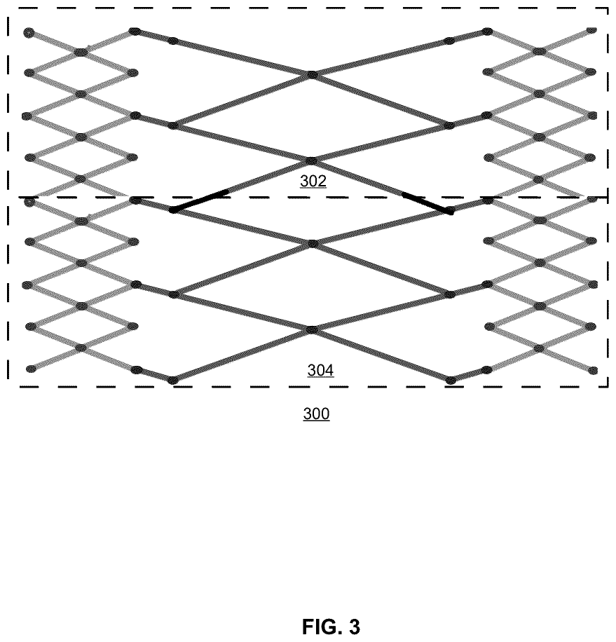

Referring to FIGS. 2A and 2B, shown is a cell of an extending truss 200 according to non-limiting embodiments. The extending truss 200 is shown in an unfolded condition 201 for purpose of illustration such that a first scissor extender 202 is connected to a second scissor extender 204 at joint u₂ and a third scissor extender 206 at joint u₃. The second scissor extender 204 is connected to the third scissor extender 206 at joint u₁ in a folded (connected) condition 208. The folded compressed front view profile 208 shows a substantially flat extension device 200 where the angle of the members at joint u₁ is greater than 135 degrees and/or the angle of the members at joints u₂ and 3 is less than 30 degrees, as examples. It will be appreciated that various angles may be present between the members due to the physical shapes of the members. FIG. 2A shows the extending truss 200 in a compressed state and FIG. 2B shows the extending truss in an extended state.

In FIG. 2B, the folded expanded profile 208 shows the extension truss 200 in a popped-up, extended state, where the angle of the members at joint u₁ is similar or closer (e.g., within 10-20 degrees or the like) to the angle of the members at joints u₂ and u₃, as an example. In an extended state, the difference between the angles of the members at joint u₁ and the angle of the members at joints u₂ and u₃ may be less than a difference of such angles in a compressed state. In non-limiting embodiments, the extending truss lies substantially flat in its compressed state and “pops up” as it transitions to the extended state, forming a triangular cross section in examples using three lengths of serially-connected scissor extenders laterally connected. In non-limiting embodiments, the extending truss may be a one-degree-of-freedom deployable structure having a triangular cross-sectional area in its deployed state to provide favorable inertial and stiffness properties. Other cross-sectional geometries, such as quadrilateral or polygon-variant, can be achieved in non-limiting embodiments by mirroring the members and/or other like modifications.

Referring now to FIG. 2C, a further view of the extending truss 200 shown in FIG. 2B is shown according to non-limiting embodiments. FIG. 2C shows the shorter scissor extender bi sides and the longer asymmetric scissor extender aᵢ sides.

Referring now to FIG. 3, an extending truss 300 is shown in an unfolded, compressed state according to non-limiting embodiments. The extending truss 300 shown in FIG. 3 includes two cells 302, 304 connected serially together. As shown, serially connected scissor extenders form each side of the extending truss 300.

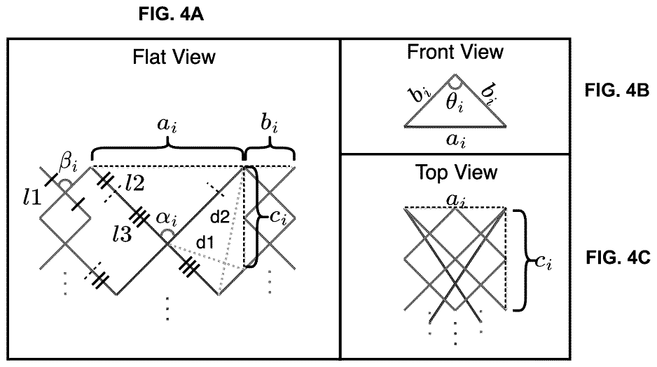

Referring now to FIG. 4A, a flat view of a cell of an extending truss is shown according to non-limiting embodiments. FIG. 4B shows a front view and FIG. 4C shows a top view of the extending truss shown in FIG. 4A. The extending truss cell combines two different scissor mechanisms connected by revolute joints. The long asymmetric scissor extender aᵢ in the middle and the shorter scissor extender bi sides are shown in FIG. 4A. The longer asymmetric scissor extender aᵢ connects with the shorter sides bi by two-degree-of-freedom (DOF) joints. This facilitates the structure opening in a substantially straight line. The long asymmetric scissor is described by l2, the offset length, and l3, half the scissor length. The side scissors are described by l1, which is half the length of the scissor. Given l1, l2, and l3, the extending truss can be fully defined with an angle α, thus making it a one-DOF mechanism. It will be appreciated that other lengths may be used, such that the two members of the asymmetric scissors are rotationally connected at a point off-center the longitudinal axis formed by the member having the combined lengths of l2 and (2×) l3.

In non-limiting embodiments, to construct an extending truss the parameters may be evaluated at several instances, i=1:I of the phase angle, αᵢ. Given l1, l2, l3, and αᵢ, the other parameters, shown in FIGS. 4A-C can all be determined through the following equations:

$${a}_{i} = ( l 2 + l 3 ) * \sqrt{( 2 * ( 1 - cos ( {α}_{i} ) ) )} \qquad ( 1 )$$

$${c}_{i} = \begin{matrix}\sqrt{{( l 2 ( sin ( {α}_{i} / 2 ) + sin ( 3 {α}_{i} / 2 ) ) )}^{2}} \\ + {( 2 cos ( {α}_{i} / 2 ) ( l 2 cos ( {α}_{i} ) + l 3 ) )}^{2}\end{matrix} \qquad ( 2 )$$

$${β}_{i} = {cos}^{- 1} ( 1 - 0.5 {( \frac{{c}_{i}}{2 l 1} )}^{2} ) + π \qquad ( 3 )$$

$${b}_{i} = l 1 * \sqrt{( 2 * ( 1 - cos ( {β}_{i} ) ) )} \qquad ( 4 )$$

$$d {1}_{i} = \sqrt{( l {3}^{2} + l {2}^{2} - 2 * ( l 3 * l 2 ) * cos ( {α}_{i} ) )} \qquad ( 5 )$$

$$d {2}_{i} = \begin{matrix}\sqrt{( ( l {2}^{2} + l {3}^{2} ) + l {3}^{2} )} \\ - 2 ( l 3 ( l 2 + l 3 ) ) cos ( π - {α}_{i} )\end{matrix} \qquad ( 6 )$$

$${θ}_{i} = {cos}^{- 1} ( ( {α}_{i}^{2} - 2 * {b}_{i}^{2} ) / ( - 2 * {b}_{i}^{2} ) ) \qquad ( 7 )$$

From these parameters, the following constraints may be satisfied for the extending truss to be kinematically feasible according to non-limiting embodiments:

$${a}_{i} \leq 2 * {b}_{i} \qquad ( 8 )$$

$${c}_{i} \leq l 2 + d {1}_{i} \qquad ( 9 )$$

$$d {1}_{i} \leq l 2 + {c}_{i} \qquad ( 10 )$$

$$d {l}_{i}^{2} + d {2}_{i}^{2} - {c}_{i}^{2} - l {3}^{2} - 2 * ( l 2 * ( l 2 + l 3 ) ) = 0 \qquad ( 11 )$$

Equations (8), (9), (10) describe triangle inequality constraints applicable to some non-limiting embodiments. Equation (11) describes the constraints on the trapezoid created by combining multiple expansion truss cells shown in FIG. 4A. To build such a system with members that have a thickness, constraints may be applied to link lengths and phase angles based on member thickness t:

$$l 1 , l 2 , l 3 > 0 \qquad ( 12 )$$

$${α}_{i} \leq 2 {cos}^{- 1} ( \frac{l 3}{\sqrt{l {3}^{2} + {t}^{2}}} ) \qquad ( 13 )$$

$${α}_{i} \geq π - 2 {cos}^{- 1} ( \frac{l 3}{\sqrt{l {3}^{2} + {t}^{2}}} ) \qquad ( 14 )$$

$${β}_{i} \leq 2 {cos}^{- 1} ( \frac{l 1}{\sqrt{l {3}^{2} + {t}^{2}}} ) \qquad ( 15 )$$

$${β}_{i} \leq π - 2 {cos}^{- 1} ( \frac{l 1}{\sqrt{l {1}^{2} + {t}^{2}}} ) \qquad ( 16 )$$

In non-limiting embodiments, to facilitate the pop-up functionality where the system fully closes and fully opens, two additional constraints may be added as follows:

$${θ}_{1} = π \qquad ( 17 )$$

$${θ}_{1} = \frac{π}{3} \qquad ( 18 )$$

where θ₁ is the folded angle of the system and Or is the final angle of the triangle in radians. It will be appreciated that various additional and/or different constraints may be applied in non-limiting embodiments.

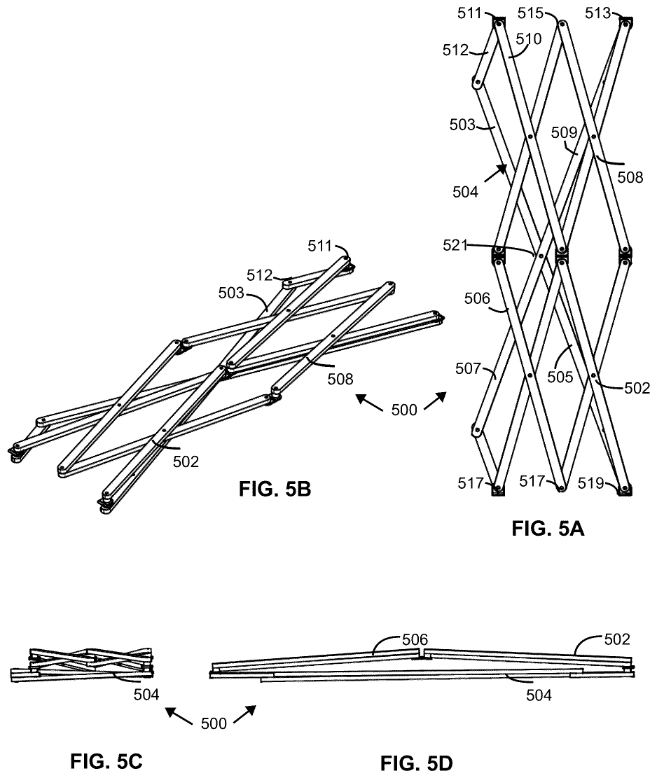

Referring to FIGS. 5A-5D, shown is an extending truss 500 according to non-limiting embodiments. The extending truss 500 shown in FIGS. 5A-5D is a single cell. In non-limiting embodiments multiple cells may be stacked (e.g., serially connected) to form a longer truss 500. FIG. 5A shows a top view of an extending truss 500 in a compressed state. The extending truss includes a first scissor extender 504 in the form of an asymmetric scissor extender having a first member and a second member. The first member has a first portion 503 and a second portion 505 separated by a revolute joint 521, and the second member has a first portion 507 and a second portion 509 separated by the revolute joint 521 connecting to the first member. In non-limiting embodiments, the first portion 503, 507 of the first and second members may be shorter in length than the second portion 505, 509 of the first and second members. A second scissor extender 502, third scissor extender 506, fourth scissor extender 508, and fifth scissor extender 510 are shown connected to the first scissor extender 504. A connector 512 may be used to rotationally connect the shorter ends 503, 507 of the first scissor extender 504 to the scissor extender 506 and scissor extender 510. Joints 511, 513, 515, 517, 519 may have two-DOF movement for connecting different scissor extenders in a cell. Joints 511, 513, 517, 519 may also be used to connect additional cells and/or scissor extenders in a serial manner. Joints 515, 517 may not connect to an additional cell or scissor extender in some non-limiting embodiments, but in other non-limiting embodiments, one or more additional scissor extenders (not shown in FIGS. 5A-5D) may be added to provide additional structural support at joint 515.

FIG. 5B shows a perspective view of the extending truss 500 shown in FIG. 5A in a compressed state according to non-limiting embodiments. FIG. 5C shows a side view of the extending truss 500 shown in FIG. 5A in a compressed state according to non-limiting embodiments. FIG. 5D shows a front view of the extending truss 500 shown in FIG. 5A in a compressed state according to non-limiting embodiments.

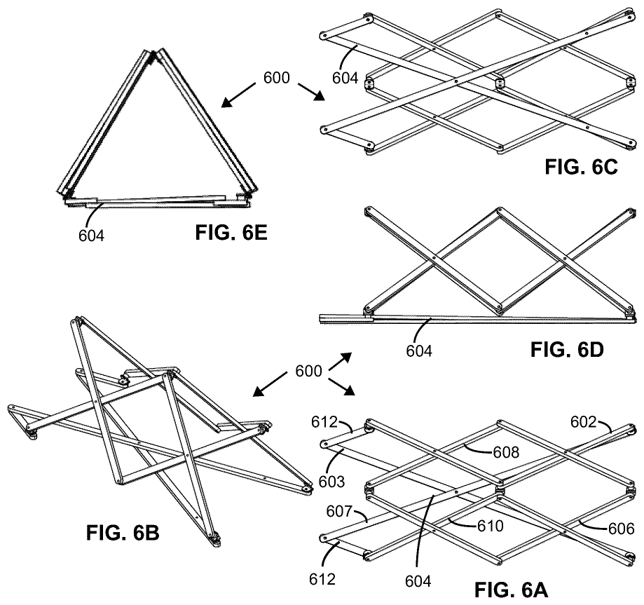

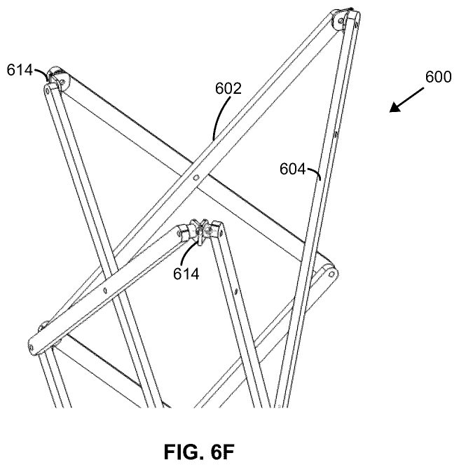

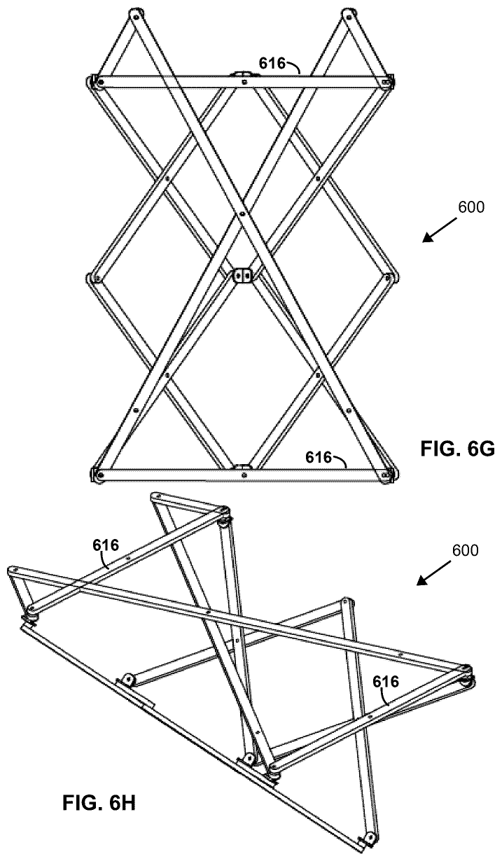

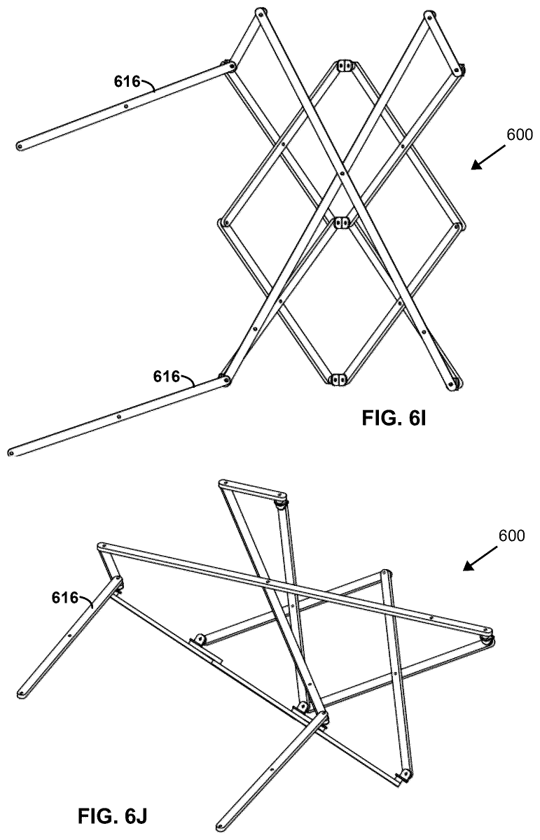

In non-limiting embodiments the elements of the extending truss 500 are structured to form a substantially triangular cross-section when in a compressed (e.g., collapsed) state (e.g., FIG. 5D), the cross-section having a height greater than zero (e.g., at least 0.01% of the length of a member of an extender). In this manner, the sides of the cell that are on top in a compressed position (e.g., a first side of shorter extenders 506, 510 and a second side of shorter extenders 502, 508) are not in a state of singularity, thereby allowing the sides to be bent up and down to “pop-up” into a triangular cross-section with a larger height (e.g., FIG. 6E).

Referring to FIGS. 6A-6J, shown is an extending truss 600 according to non-limiting embodiments. FIGS. 6A-6F show the extending truss of FIGS. 5A-5D in an extended state. FIG. 6A shows a top view of an extending truss 600 in an extended state. The extending truss includes a first scissor extender 604 in the form of an asymmetric scissor extender having a first member and a second member. A second scissor extender 602, third scissor extender 606, fourth scissor extender 608, and fifth scissor extender 610 are shown connected to the first scissor extender 604. A connector 612 may be used to rotationally connect the shorter ends 603, 607 of the first scissor extender 604 to the scissor extender 606 and scissor extender 610. FIG. 6B shows a perspective view of the extending truss 600 shown in FIG. 6A in an extended state according to non-limiting embodiments. FIG. 6C shows a side view of the extending truss 600 shown in FIG. 6A in an extended state according to non-limiting embodiments. FIG. 6D shows a bottom view of the extending truss 600 shown in FIG. 6A in an extended state according to non-limiting embodiments. FIG. 6E shows a front view of the extending truss 600 shown in FIG. 6A in an extended state according to non-limiting embodiments.

FIG. 6F shows a perspective view of the extending truss 600 shown in FIG. 6A in an extended state according to non-limiting embodiments. FIG. 6F shows joints 614 that attach different scissor extenders laterally in a cell. The joints 614 may include a combined rotational and hinge joint. To connect different scissor extenders together, any type of joint connection mechanism may be used that permits the sides to pop up into a truss structure when expanded. In some non-limiting embodiments, a flexure may be used as a joint connecting the members. The flexure may be compliant, such as but not limited to a metal, plastic, and/or rubber flexure. In non-limiting embodiments, various types of joints may be used to rotationally connect the members of each scissor extender, to connect different scissor extenders together laterally in a cell, and to serially connect a length of scissor extenders.

The joint 614 may include, in non-limiting embodiments, bendable wire, fiber, and/or other materials that approximate the movement of a ball and socket joint. In non-limiting embodiments, the joint 614 may be a two-DOF connection, such as a revolute joint combined with a hinge joint (e.g., a hinge joint that is free to rotate between the scissor faces) as shown in FIG. 6F. Alternatively, a ball and socket joint may be used in some non-limiting embodiments. To serially connect a length of scissor extenders, the ends of the members of the scissor extenders may be designed to include a pressed overhang with a loose peg and spoke fit-in once the outer flange is passed. Such a design may also be used to rotationally connect the members of each scissor extender in non-limiting embodiments.

FIG. 6G shows a top view of an extending truss 600 with locking mechanisms 616 locking the extending truss 600 in an extended state according to non-limiting embodiments. FIG. 6H shows a perspective view of an extending truss 600 with locking mechanisms 616 attached according to non-limiting embodiments. FIG. 6I shows a top view of an extending truss 600 with locking mechanisms 616 unattached according to non-limiting embodiments. FIG. 6J shows a perspective view of an extending truss 600 with locking mechanisms 616 unattached according to non-limiting embodiments. In non-limiting embodiments, one or more locking mechanisms may be configured to lock the first scissor extender, the second scissor extender, and/or the third scissor extender in an at least partially extended state. In non-limiting embodiments, the locking mechanism may include cables, pins, ratchets, hydraulic clamps, and/or the like. In some non-limiting embodiments, the locking mechanism may include additional structural components that latch onto one another, turning the scissor assembly into a stabilized triangular truss or a truss of another shape. Once such supplemental elements are engaged, they may create a defined shape, such as a triangle, adding additional structural integrity. This added rigidity helps the system withstand prolonged loads without collapsing back to its compressed or initial state.

In non-limiting embodiments, an extending truss may include extension mechanisms other than scissor extenders. For example, one or more lengths of serially-connected extension mechanisms may be used to form an extending truss. In some non-limiting embodiments, one or more sides of an extending truss may include non-scissor extension mechanisms and one or more sides may include scissor extension mechanisms. Further, it will be appreciated that in some non-limiting embodiments, an extending truss may be constructed from different cells connected serially together, such that at least one cell includes an asymmetric scissor extender as described herein. Other cells may include all symmetric scissor extenders and/or different types of extension mechanisms. Thus, in non-limiting embodiments, the stacked cells do not need to be identical cells but can vary.

In non-limiting embodiments, the extending truss can be used for various purposes, offering quick deployment, high stability, and compact storage capabilities. For example, in developing deployable structures for satellites, spacecraft, and space stations, an extending truss could provide a lightweight, compact, yet robust solution. In a construction application, extending trusses could be utilized for temporary or modular structures, particularly in emergency or disaster relief scenarios where rapid setup and stability are critical. Military and defense applications might use extending trusses for swiftly establishing temporary bases, fortifications, or other structures in diverse and challenging terrains. In the automotive industry, the extending truss could be adapted for use in vehicle frames or other components that require a strong, lightweight, and compact structure. Further, extending trusses may be used for robotic arms or structural supports, enhancing range of motion and strength in robotic applications. Marine engineering applications, such as underwater vehicles and structures, could incorporate extending truss designs for deployable components, utilizing the compactness and robustness of the structures.

In healthcare applications, extending trusses could be used for quick-deploy medical shelters or field hospitals, providing a reliable and rapid response solution. Such structures may also be used for the fast setup and teardown of theatrical stages, concert structures, and outdoor or indoor event infrastructures. In renewable energy, extending trusses could be used to create easily deployable and adjustable structures for wind and solar farms, optimizing efficiency. Telecommunications applications include the use of extending truss-based mobile towers and antennas, facilitating rapid deployment and scalability. Extending trusses could also be used to provide temporary or deployable platforms, shelters, or other infrastructures at bus and train stations or airports.

Consumer goods, such as foldable furniture, camping gear, or collapsible storage solutions, may be developed using extending trusses. In logistics and supply chain management, extending trusses could be applied to create adjustable shelving or storage solutions that can be quickly deployed or retracted as needed. Extending trusses could also be used for temporary housing for livestock or quick-setup greenhouses, offering flexibility for seasonal or migratory farming practices. It will be appreciated that there are various other uses and applications for one or more extending trusses as described herein.

In non-limiting embodiments of an extending truss, the sub-structures (e.g., each length of serially-connected scissor extenders) may achieve multiple axes of reorientation. This unique composition enables both the extension and expansion of the structure to simultaneously create a triangular truss configuration or other shapes depending on the number of scissor extenders connected laterally (e.g., the number of sides to a cell). In a compressed (e.g., stowed) state, the longer members of at least one of the scissor extenders (e.g., an asymmetrical scissor extender) may have the approximate width of two smaller scissor extenders, allowing them to pack flat. As the extension device deploys (e.g., expanded into an extended state), the width of the long scissor extenders changes at a different rate than the short scissor extenders, forcing the long scissor extenders to compensate by pivoting out of the plane and popping up (e.g., rotating with respect to the plane) into a triangular shape (e.g., in the case of three scissor extenders). This increases the minimum bending moment of inertia for the structure as it deploys, making it more resistant to bending and buckling. In non-limiting embodiments, as the extension of the truss increases, its flexural modulus (a metric used to evaluate bending stiffness measured in the deployed state) increases at a greater rate than that of the scissors and, in one example, with a maximum of 71% improvement over the solid beam.

In non-limiting embodiments, extending trusses may be designed and constructed by modeling the structures as beam-based structures using finite element methods (FEM) to estimate the comparative structural behavior between different geometries and design parameters.

Maintaining a constant underlying material type and elastic modulus (E), the stiffness of individual beams predominantly varies based on their bending moment of inertia:

$${I}_{∝} = {\int }_{A} {y}^{2} dA or {I}_{y} = {\int }_{A} {x}^{2} dA .$$

Moving the supporting mass farther from the centroid makes the geometry more resistant to bending and buckling. However, local and global deformation modes for truss and lattice-based structures may be considered as constituent beam aspect ratios and densities change. In non-limiting embodiments, the flexural modulus may be estimated from the FEM analysis using a cantilevered beam test with the following equation:

$$EI = \frac{{FL}^{3}}{3 d}$$

where E is Young's modulus, I is the bending moment of inertia, F is the applied load, L is the effective length of the mechanism, and dis the displacement. Holding mass constant, an extending truss with square-cross section beams may have a 50% stowing advantage over a scissor mechanism with the same packing angle and mass, resulting in a rectangular cross-section. Tests with non-limiting embodiments show that an extending truss can achieve a 107% advantage over a long-link scissor (e.g., standard scissor mechanism) and a 114% advantage in bending over a small-link scissor (e.g., standard scissor mechanism). It will be appreciated that various different advantages and results may be achieved with different non-limiting embodiments.

### Hierarchical Extension Device

In non-limiting embodiments, a hierarchical extension device may include a first and second extension mechanism in combination such that each first extension mechanism is configured to be compressed into a compressed state having a compressed length and extended into an extended state having an extended length, and such that the second extension mechanism includes a plurality of members configured to be compressed into a compressed state and extended into an extended state without altering a length of the plurality of members. Each member of the plurality of members may include a first extension mechanism of the plurality of first extension mechanisms. In this manner, a hierarchical extension device may be stratified with respect to extension mechanisms. A hierarchical extension device may be used as a high-expansion ratio deployable structure for various applications. In non-limiting embodiments, the members are mechanically fastened with a pivotable connection mechanism to an object, such as a plate, on each end of the device such that a first member of the two or more members is pivotable with respect to a second member of the two or more members.

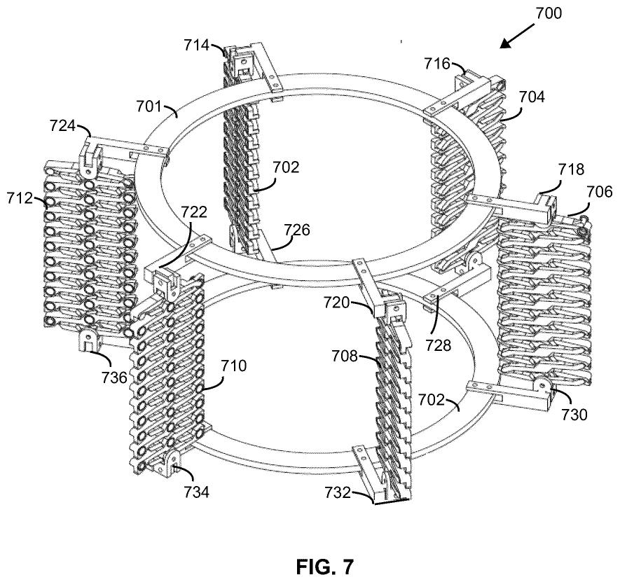

Referring to FIG. 7, a hierarchical extension device 700 is shown according to non-limiting embodiments. The hierarchical extension device 700 includes a plurality of first extension mechanisms 702, 704, 706, 708, 710, 712. In the illustrated example each first extension mechanism is a plurality of serially-connected scissor extenders. It will be appreciated that any extension mechanism may be used that can compress and extend, such as but not limited to the pop-up extending truss described herein. The first extension mechanisms 702, 704, 706, 708, 710, 712 form support members in a compressed position shown in FIG. 7. The support members may extend into elongated support members, extending the distance between a first end 701 and second end 703 of the hierarchical extension device 700. The first end 701 and/or second end 703 may include plates or other objects. Although six extension mechanisms 702, 704, 706, 708, 710, 712 are shown in FIG. 7, it will be appreciated that any number may be used in different non-limiting embodiments.

With continued reference to FIG. 7, the arrangement of the first extension mechanisms 702 with respect to the first end 701 and second end 703 may form a second extension mechanism. For example, joints 714, 716, 718, 720, 722, 724 may connect the first extension mechanisms to the first end 701 and joints 726, 728, 730, 732, 734, 736 may connect the first extension mechanisms to the second end 703. The joints may be configured to pivot the first extension mechanisms with respect to a plane of the first end 701 and second end 703. In this manner, twisting the first end 701 and/or second end 703 and applying pressure to compress them together may cause the joints to pivot and for the first extension mechanisms to collapse to a substantially flat state (e.g., flat with respect to a plane of the first end 701 and/or second end 703).

FIG. 7 shows a hierarchical extension device 700 as a single cell. It will be appreciated that multiple cells may be combined and stacked serially to form an elongated extension device. For example, the device 700 shown in FIG. 7 may be replicated and stacked on top such that a second device sits on top of the first end 701. The second end (e.g., bottom end) of the second cell may be separate or the same as (e.g., integral with) the first end 701.

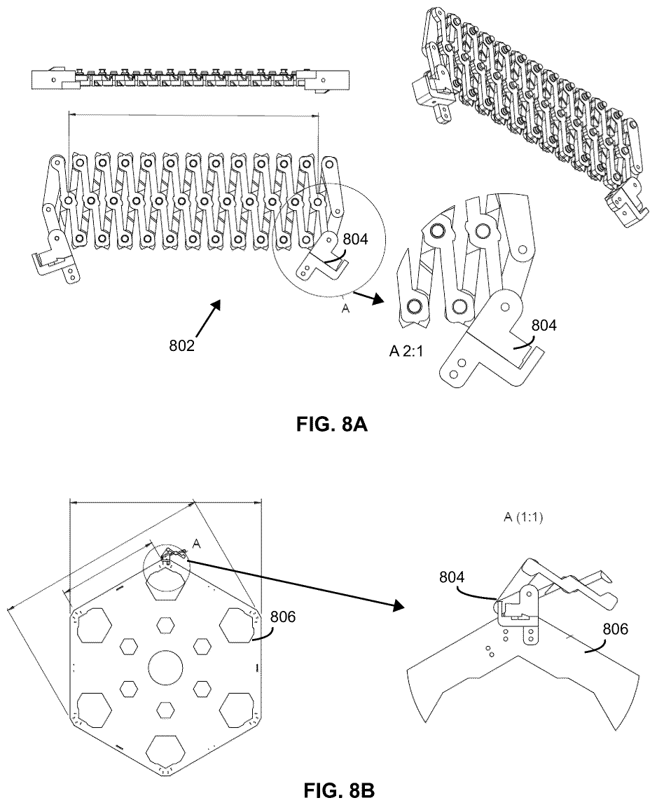

FIG. 8A shows a first extension mechanism 802 and connection mechanism 804 according to non-limiting embodiments. The first extension mechanism 802 and connection mechanism 804 may be usable in the configuration shown in FIG. 7. The connection mechanism 804 may be configured to pivot the first extension mechanism. FIG. 8B shows the connection mechanism 804 connected to a plate 806 acting as a first end, second end, or middle portion of a hierarchical extension device. A connection mechanism may include any joint or other device that pivotably connects two objects.

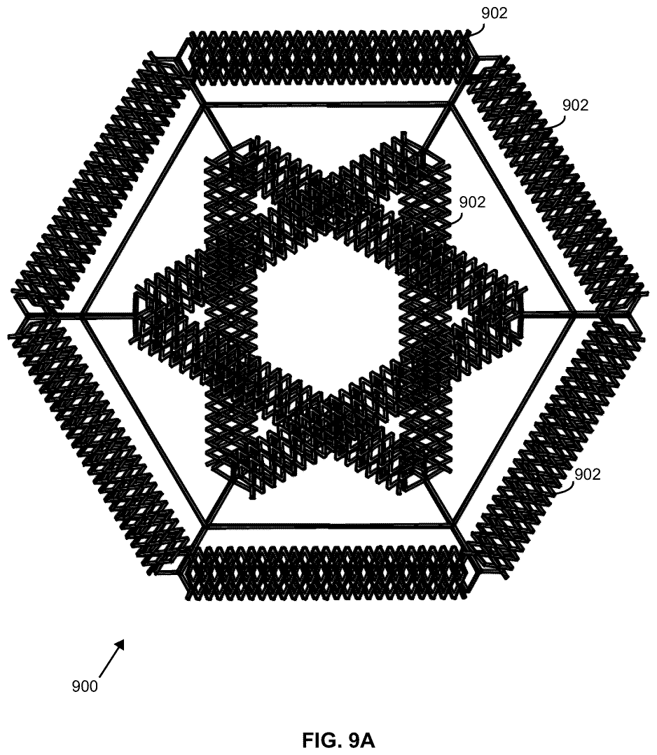

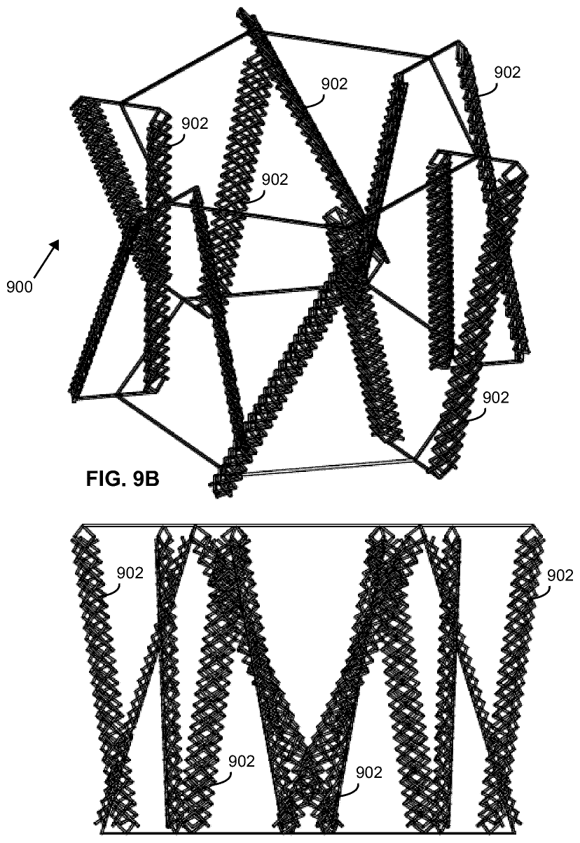

FIG. 9A shows a hierarchical extension device 900 in a compressed state, where first extension mechanisms 902 are each in a compressed state and where the first extension mechanisms 902 have been collapsed in a compressed state as part of the second extension mechanism assembly (e.g., a Kresling structure in the example shown). FIG. 9B shows the hierarchical extension device 900 from FIG. 9A in an extended state, where the first extension mechanisms 902 have been expanded in an extended state as part of the second extension mechanism assembly (e.g., a Kresling structure in the example shown) which has also been extended.

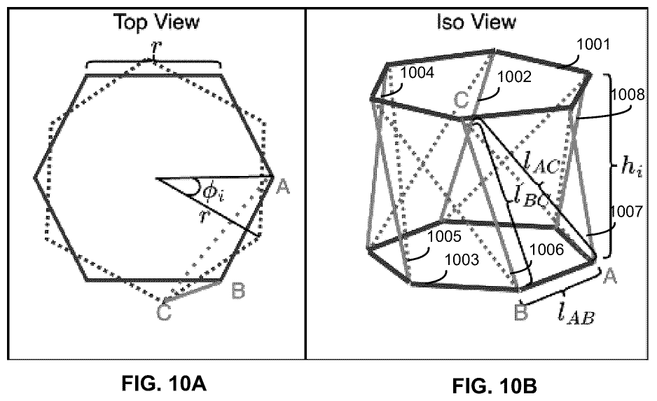

FIGS. 10A and 10B show a Kresling structure that can be used as one of two or more extension mechanisms in a non-limiting embodiment of a hierarchical extension device. FIG. 10A shows a top view and FIG. 10B shows a perspective view. A first end 1001 and second end 1003 are connected with members 1002, 1004, 1005, 1006, 1007, 1008 where each member is a first extension mechanism. The broken lines represent a partially compressed state in which the members (e.g., 1004) are pivoted with respect to the first end 1001 and/or second end 1003.

It will be appreciated that a hierarchical extension device may be constructed from any combination of two or more types of extension devices. In non-limiting embodiments, the first extension device(s) may include elongated members that expand and contract, such as a length of scissor extenders, an extending truss, a telescoping member, and/or the like. In non-limiting embodiments, the second extension device(s) may include structures including elongated members that are configured to collapse and/or contract with or without changing the length of the elongated members (e.g., with rigid elongated members), such as a Kresling structure (e.g., Kresling mechanism), handed shearing auxetics, and/or the like.

A Kresling structure with rigid components and standard joints may include two primary components: outer rigid members and inner extendable members. This system may be parameterized with the height h, the radius r, and the twist angle φᵢ seen in FIG. 10A. The following additional parameters can be determined from the following equations:

$${l}_{AB} = 2 r sin ( \frac{π}{6} ) \qquad ( 19 )$$

$${l}_{BC} = \sqrt{{h}^{2} - 2 {r}^{2} cos ( ϕ ) + 2 {r}^{2}} \qquad ( 20 )$$

$${l}_{AC} = \sqrt{{h}^{2} - 2 {r}^{2} cos ( \frac{2 π}{6} + ϕ ) + 2 {r}^{2}} \qquad ( 21 )$$

where I_{AB} is the side length of the hexagon, I_{BC} is the length of the outer member, and lac is the extendable inner member.

In some non-limiting embodiments, the following equations may be used for certain use cases, although it will be appreciated that various other design constraints may additionally or alternatively be considered depending on the application and other considerations:

$$D = 2 {l}_{AB} + 2 {α}_{1} \qquad ( 22 )$$

$${a}_{1} = < {l}_{AB} \qquad ( 23 )$$

$$n * {c}_{1} = {l}_{BC 1} = D / 2 \qquad ( 24 )$$

$$n * {c}_{f} = {l}_{BC f} = {l}_{ACf} \qquad ( 25 )$$

$$m * {h}_{1} \leq {H}_{0} \qquad ( 26 )$$

$$m * {h}_{f} \geq {H}_{f} \qquad ( 27 )$$

$$V = 12 {m ( 2 t )}^{2} * ( 8 n ( 2 l 1 ) + 2 n ( 2 l 3 + l 2 ) ) \qquad ( 28 )$$

$$ρ * V \leq M \qquad ( 29 )$$

$$n , m ∈ II \qquad ( 30 )$$

In the above equations, D is the fairing diameter, H₀ is the fairing height, H_{f} is the final deployed length, M is the max payload, tis half the thickness of a member, Vis an approximation for the total volume, ρ is the density of the material, n is the discrete number of scissor extender cells, and m is discrete number of Kresling structure cells.

In non-limiting embodiments, the design of a superstructure with both continuous parameters and integer parameters can be formulated as the following mixed-integer nonlinear program:

$${minimize}_{x , y} ℓ ( x , y )$$

$$subject to ( 8 ) - ( 30 )$$

where x=[l1, l2, l3, t, α_{i=1:1}, r, φ=_{1:1}, h_{i=1:1}] and y=[n,m], and where [symbol] (⋅) is an objective function. The objective function can be task-specific. For example, a continuous and differentiable objective function may be chosen that enables existing solvers to find solutions efficiently. The objective function chosen may seek to minimize the aspect ratio of the members since long, skinny members are prone to buckling. Given the design constraints of an example use case of space vehicles and mission constraints of a 1 km long structure, feasible configurations can be generated using this formulation. It will be appreciated that additional and/or alternative formulas may be used to select design parameters.

Through sliding, wrapping, and/or pivoting one or more members, extending structures can both stow and expand, manipulating the pose of material members and thus volume. When fully deployed (e.g., extended), such structures can have high length-to-width ratios, making them vulnerable to bending and buckling. Therefore, the structure extension ratio (ER) (the ratio of the final length to the stowed length) and flexural modulus (EI) may be considered to assess a structure for load-bearing applications. In non-limiting embodiments, a single parameter, such as the angle between members of a scissor extender, can represent the state of the structure. A structure designed to achieve a high extension ratio can maximize the packing density by pivoting, sliding, and/or wrapping the subcomponents in relation to one another. The volume of a pivoting 1-DOF mechanism, such as a scissor mechanism or Kresling, transforms based on the rotation of the internal beams.

The extension ratio for a standard scissor extender may be expressed by:

$${ER}_{scissor} = \frac{l * cos ( {α}_{f} )}{l * cos ( {α}_{i} )} \approx \frac{l}{t} when cos ( {α}_{f} ) \approx 1 \& n >> 1$$

where αᵢ, α_{f} are the initial and final angles of the scissor, l is the link length of the scissor, tis the thickness of the link, and n is the number of scissor units connected together. The extension ratio of the scissor mechanism is the ratio of the cosine of the final angle between the members over the initial angle of the members. This extension ratio of a scissor can be approximated as the aspect ratio of an individual member when there are many scissor units combined.

The extension ratio of a Kresling mechanism may be expressed by:

$${ER}_{Kresling} = \frac{r \sqrt{( 2 * cos ( {ϕ}_{f} ) - 1 )}}{r \sqrt{( 2 * cos ( {ϕ}_{i} ) - 1 )}} \approx \frac{r}{2 t} when \frac{t}{r} << 1$$

where r is the radius of the mechanism, di, of are the angle offsets between the top and bottom plates of the Kresling structure, and t is the thickness of the Kresling members. In this example, the extension ratio is a ratio of the final angle to the initial angle and can be approximated as an aspect ratio of the Kresling members.

To achieve high extension ratios for these mechanisms, high aspect ratio elements are used which are prone to local buckling when subjected to loads. Similarly, for other 1-DOF mechanisms that use pivoting and sliding deployment, these designs only contain a single packing direction. This means that the magnitude of a possible extension (e.g., amount of expansion) is fully determined by the dimensions of the initial bounding volume and the thickness of the individual members used to construct the mechanism This problem is exacerbated in the practical design of deployable mechanisms when the original bounding dimensions are constrained, leading to making individual members thinner and leaving designs susceptible to buckling and local deformation.

In non-limiting embodiments, non-planar hierarchy can be used to increase the extension ratio while maintaining favorable member aspect ratios. As an example, scissor extenders and the Kresling pattern may be combined. This structure hierarchically extends through multiple sequential reorientations of the individual elements. This hierarchical composition enables tighter packing of the sub-mechanisms to achieve high extension ratios. The extension ratio from the hierarchically combined structures is approximately as follows:

$${ER}_{HERDS} = \frac{n * l * cos ( {α}_{f} )}{r \sqrt{( 2 * cos ( {ϕ}_{i} ) - 1 )}} \approx \frac{n * l}{2 t} \approx \frac{r * l}{2 {t}^{2}} when cos ( {α}_{f} ) \approx 1 \& \frac{t}{f} << 1$$

where α_{f} is the angle of the scissor mechanism, φᵢ is the twist angle of the Kresling, t is the thickness of the scissor links, n is the number of scissor units, l is the length of the scissor links, and r is the radius of the Kresling structure. The hierarchical composition increases the number of tunable parameters to achieve high extension, including the number of scissor units, Kresling deployment angle, Kresling radius, and member aspect ratio, as examples.

In non-limiting embodiments, the hierarchical composition of mechanism transformations happen sequentially. The Kresling transformation, T[φ], may be performed first, reorienting the scissor mechanism. Then, the transformation of the scissor mechanism, T[α], can deploy the sub-components smoothly, increasing the system extension. These transformations may not be commutable; for example, in the collapsed state, the scissor mechanism's transformation, T[α], may not lead to the effective extension of the mechanism. It will be appreciated that a different sequence may be used in non-limiting embodiments, such that the scissor mechanism transformation occurs first.

By manipulating the orientation of substructure stacking through hierarchical design, high packing efficiency may be achieved without increasing the component aspect ratio. This demonstrates the benefits of hierarchical deployable structures for extension ratio. The stiffness of the deployed structure depends on the final deployed architecture.

Non-limiting embodiments may use a scissor extender for the elongated members of a hierarchical extension device, as shown in FIGS. 7, 8A, 8B, 9A, and 9B. A standard scissor mechanism has a low flexural modulus when fully deployed, making it susceptible to bending failures. Using a standard scissor mechanism as a substructure provides a flexural modulus (bending stiffness) that is less than that of a solid beam. Non-limiting embodiments may use an extending truss, as described herein, for the elongated members of a hierarchical extension device to improve the structural support and strength. It will be appreciated that various other extension mechanisms may be used in non-limiting embodiments.

Superstructure analysis of a hierarchical extension device may be computationally difficult and/or infeasible due to the large number of parts and the scale of the design. However, the scissor mechanisms and/or extending trusses and Kresling structure may be approximated as “line bodies” to enable a faster and more computationally efficient evaluation. A “line body” in simulation may represent a one-dimensional entity with a defined cross section but no surfaces, making it sufficient to represent slender structures like beams, rods, and cables. Line bodies may account for bending, axial deformation, and torsion effects. Line bodies may significantly reduce computational resources and time when compared to modeling a full 3D geometry of slender structures. For example, the multi-component extending truss may be approximated as a line body with a hollow tube cross-section. This cross section is designed to have the same total area as the extending truss cross section and the same area moment of inertia as the cross section of the extending truss that experiences maximum stress. The homogenized beam cross section may be calculated by first running a finite element tension test to compute the effective cross-sectional area (A) based on the Young's modulus (E), tension force (F), and strain (E) of the material used, such that: A_{effective}=F/ϵE. Next, the bending stiffness may be tested by applying a deformation and measuring the resultant force. Approximating the beam as an Euler-Bernoulli beam with aspect ratio >10, the effective beam area moment of inertia may be I=FL³/3δE. Then a hollow circular cross section with matching area and moment of inertia with inner and outer diameters can be solved for with the following:

$${D}_{i} = \frac{\sqrt{8 p - \frac{2 {A}^{2}}{π}}}{\sqrt{A}}$$

$${D}_{o} = 2 \sqrt{\frac{A}{π} - {( \frac{{D}_{i}}{2} )}^{2}}$$

While this line body approximation may not precisely match the original extending truss, the homogenized version preserves some characteristics and enables functional analysis of the complete structure. To approximate the behavior of an entire 1 km length superstructure, a similar homogenization may be performed and loads may be applied as parameter values to assess use-specific requirements.

In non-limiting embodiments, a hierarchical extension device may be designed to prevent or reduce jamming. For example, 1-DOF systems are prone to jamming due to the large number of constraints. Hierarchically combining two such systems into a hierarchical extension device may therefore cause multiple jamming issues. In non-limiting embodiments, a hierarchical extension device may be designed by modeling this potential failure point. For example, a Monte Carlo simulation may be used to simulate the influence of tolerance noise on a one-cell extending truss mechanism. This allows for the emulation of uncertainties and variations when joint tolerances are affected by manufacturing processes or other external factors. For each distinct configuration within a range of dimensions, several (e.g., 50) individual examples may be generated to minimize the norm of the joint distances, effectively allowing for the lowest energy configuration for each pose to be identified.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. An extending truss comprising a plurality of cells, each cell comprising:
a first scissor extender comprising a first member and a second member rotationally connected to the first member at an off-center point along a longitudinal axis of the first member;
a second scissor extender connected to the first scissor extender, the second scissor extender comprising a first member and a second member rotationally connected to the first member; and
a third scissor extender connected to the first scissor extender, the third scissor extender comprising a first member and a second member rotationally connected to the first member.

2. The extending truss of claim 1, wherein the first member and the second member of the first scissor extender each comprise a first end and a second end, wherein the first member and the second member of the second scissor extender each comprise a first end and a second end, wherein the first member and the second member of the third scissor extender each comprise a first end and a second end, and wherein each cell further comprises a plurality of joints including:
a first joint connecting the first end of the first member of the second scissor extender with the second end of the second member of the first scissor extender;
a second joint connecting the first end of the second member of the second scissor extender with the second end of the first member of the first scissor extender;
a third joint connecting the second end of the second member of the third scissor extender with the first end of the first member of the first scissor extender; and
a fourth joint connecting the second end of the first member of the third scissor extender with the first end of the second member of the first scissor extender.

3. The extending truss of claim 2, wherein each joint of the plurality of joints comprises a compliant flexure.

4. The extending truss of claim 1, wherein each cell further comprises at least one additional scissor extender comprising a first member and a second member rotationally connected to the first member, the at least one additional scissor extender connected to the first scissor extender, the second scissor extender, and/or the third scissor extender.

5. The extending truss of claim 1, wherein the plurality of cells are arranged as support members of a Kresling structure.

6. The extending truss of claim 1, further comprising a locking mechanism configured to lock the first scissor extender, the second scissor extender, and/or the third scissor extender in an at least partially extended state.

7. The extending truss of claim 1, wherein a length of the first member and the second member of the third scissor extender and/or second scissor extender is shorter than a length of the first member and the second member of the first scissor extender.

8. The extending truss of claim 1, wherein the first scissor extender further comprises a revolute joint rotationally connecting the first member and the second member of the first scissor extender.

9. An extension device comprising:
a plurality of first scissor extenders serially connected, at least one first scissor extender of the plurality of first scissor extenders comprising a first member and a second member rotationally connected to the first member at an off-center point along a longitudinal axis of the first member;
a plurality of second scissor extenders serially connected, each second scissor extender of the plurality of second scissor extenders comprising a first member and a second member rotationally connected to the first member, the plurality of second scissor extenders connected to the plurality of first scissor extenders; and
a plurality of third scissor extenders serially connected, each second scissor extender of the plurality of second scissor extenders comprising a first member and a second member rotationally connected to the first member, the plurality of third scissor extenders connected to the plurality of first scissor extenders.

10. The extension device of claim 9, further comprising:
a plurality of joints connecting the plurality of first scissor extenders to the plurality of third scissor extenders and the plurality of second scissor extenders.

11. The extension device of claim 10, wherein the plurality of joints comprises compliant flexures.

12. The extension device of claim 9, comprising:
a plurality of fourth scissor extenders serially connected, each fourth scissor extender of the plurality of fourth scissor extenders comprising a first member and a second member rotationally connected to the first member, the plurality of fourth scissor extenders connected to the plurality of second scissor extenders and the plurality of three scissor extenders.

13. The extension device of claim 9, wherein the plurality of first scissor extenders forms a first elongated member, wherein the plurality of second scissor extenders forms a second elongated member, and wherein the plurality of third scissor extenders forms a third elongated member, further comprising:
a first end connector at a first end of each of the first elongated member, the second elongated member, and the third elongated member; and
a second end connector at a second end of each of the first elongated member, the second elongated member, and the third elongated member,
wherein the first elongated member, the second elongated member, and the third elongated member are arranged as members of a Kresling structure comprising a top portion connected to at least one first end connector and a bottom portion connected to at least one second end connector.

14. The extension device of claim 9, further comprising a locking mechanism configured to lock a pop-up extender in an at least partially extended position.

15. The extension device of claim 9, wherein the locking mechanism comprises a member configured to rigidly connect two members of at least one scissor extender.

16. The extension device of claim 9, wherein a length of the first member and the second member of each second scissor extender is shorter than a length of the first member and the second member of each first scissor extender.

17. The extension device of claim 9, wherein the extension device is configured to be substantially flat in a configuration where each first scissor extender, each second scissor extender, and each third scissor extender are substantially compressed, and wherein the pop-up extender is configured to form a structure with a three-dimensional cross section in a configuration where each first scissor extender, each second scissor extender, and each third scissor extender are at least partially extended.

18. A cell of a pop-up extending truss comprising:
a first scissor extender comprising a first member and a second member rotationally connected to the first member at an off-center point along a longitudinal axis of the first member;
a second scissor extender connected to the first scissor extender, the second scissor extender comprising a first member and a second member rotationally connected to the first member; and
a third scissor extender connected to the first scissor extender, the third scissor extender comprising a first member and a second member rotationally connected to the first member.

19. The cell of claim 18, wherein the first member and the second member of the first scissor extender each comprise a first end and a second end, wherein the first member and the second member of second scissor extender each comprise a first end and a second end, and wherein the first member and the second member of the third scissor extender each comprise a first end and a second end, further comprising:
a first joint connecting the first end of the first member of the second scissor extender with the second end of the second member of the first scissor extender; and
a second joint connecting the second end of the second member of the third scissor extender with the first end of the first member of the first scissor extender.

20. The cell of claim 19, wherein the first joint and the second joint each comprise a compliant flexure.

21. The cell of claim 18, wherein a length of the first member and the second member of the second scissor extender is shorter than a length of the first member and the second member of the first scissor extender.

22. The cell of claim 18, comprising at least one additional scissor extender comprising a first member and a second member rotationally connected to the first member, the first member and the second member of second first scissor extender each having a first end and a second end, and the at least one additional scissor extender connected to the first scissor extender, the second scissor extender, and/or the third scissor extender.

23. The cell of claim 18, further comprising a locking mechanism configured to lock the first scissor extender, the second scissor extender, and/or the third scissor extender in an at least partially extended state.

24. The cell of claim 18, wherein a length of the first member and the second member of the second scissor extender is shorter than the length of the first member and the second member of the first scissor extender, and wherein a length of the first member and the second member of the third scissor extender is shorter than the length of the first member and the second member of the first scissor extender.

25. An extension device, comprising:
a first extension assembly comprised of two or more members mechanically fastened such that a first member of the two or more members is pivotable with respect to a second member of the two or more members, wherein pivoting of the first member with respect to the second member compresses and extends the first extension assembly; and
a second extension assembly comprised of one or more first extension assemblies, a first end, and a second end.

26. The extension device of claim 25, wherein the first extension assembly maintains a state of compression or a state of extension during rotation of the first end with respect to the second end.

27. The extension device of claim 25, wherein rotation of the first end with respect to the second end compresses and extends the second extension assembly.

28. The extension device of claim 25, wherein pivoting the first member with respect to the second member compresses and extends the first extension assembly when the second extension assembly is in an extended state.

29. The extension device of claim 25, wherein the first extension assembly comprises a plurality of scissor extenders.

30. The extension device of claim 25, wherein the second extension assembly comprises a Kresling structure.
